(19) United States
(12) Patent Application Publication
(10) Pub. No.: US 2023/0033904 A1
(43) Pub. Date: Feb. 2, 2023

(54) SYSTEM AND METHOD FOR GENERATING BUSINESS ONTOLOGIES AND GLOSSARIES FROM METADATA

(71) Applicant: Illumex Technologies, Ltd., Tel Aviv (IL)

(72) Inventor: Inna TOKAREV SELA, Tel Aviv (IL)

(73) Assignee: Illumex Technologies, Ltd., Tel Aviv (IL)

(21) Appl. No.: 17/814,677

(22) Filed: Jul. 25, 2022

Related U.S. Application Data
(60) Provisional application No. 63/226,561, filed on Jul. 28, 2021.

(51) Int. Cl. G06F 16/28; G06F 16/2455

(52) U.S. Cl. CPC G06F 16/288; G06F 16/2455

(57) ABSTRACT

A system and method for generating a customer ontology for a business glossary, are disclosed. The method includes receiving a data schema from a customer environment, the data schema including a plurality of semantic elements; detecting a group of semantic elements in the plurality of semantic elements, the group corresponding to a unique element; generating, for each unique element, a node in the customer ontology; parsing a query received from the customer environment, the query including a first element and a second element; determining a relationship between the first element and the second element based on the query; and generating a vertex in the customer ontology between a first node representing the first element and a second node representing the second element, based on the determined relationship

### CROSS-REFERENCE TO RELATED APPLICATIONS

This application claims the benefit of U.S. Provisional Application No. 63/226,561 filed on Jul. 28, 2021, the contents of which are hereby incorporated by reference.

### TECHNICAL FIELD

The present disclosure generally relates to big data processing, specifically to generating metadata-based ontologies to improve the discovery and understanding of big data.

### BACKGROUND

Organizations and individuals alike generate enormous amounts of data. Consistently, it is viewed that such data is valuable when it can be appropriately used by a business. Business intelligence, for example, is a methodology and suite of tools used to gain insight from large data sets. Such sets are stored in data warehouses, data lakes, and other such repositories.

As businesses grow and evolve so too do their data storage and processing needs. It is not uncommon to find a business utilizing several different tools to store and manage its data. For example, an employee may have their details stored on an HR platform, such as Gusto®, and on a customer relationship management (CRM) platform, such as Salesforce®. Each of these systems stores different aspects tied to a single identity of an individual. Having large amounts of data that are related but not necessarily connected, i.e., due to being generated by and stored in different platforms, often fails to provide value for a user while incurring the cost of storing and managing such data.

Data catalog tools such as Collibra®, Alation®, and the like leverage data, including values, schemas, and logs, to provide users the ability to add business and usage descriptions. The individual user from the above example will appear in such tools in multiple places with different descriptions across multiple different data stores, platforms, etc., meaning there are multiple representations of what is a single entity.

Cataloging and management tools often require a manual process to build a business glossary, which is a list of terms and their definitions. The business glossary ensures data uniformity across multiple platforms and throughout all data generation and analysis. The manual process is tedious and error-prone, as it is done by a human. Further, it is often subjective and may not be consistent, which can render a data set unreliable, as consistency is of utmost importance when organizing data. Inconsistency may manifest in inconsistent terminology and metrics. For example, what is considered an “active user” under one department of an organization, may not be considered an “active” user in another department of the same organization. As another example, a metric such as lifetime value (LTV) may be calculated differently between customer success departments and sales departments of the same organization.

Furthermore, mere automation of the above-mentioned manual process would still result in a system that does not provide discoverability, i.e., the ability to discover new connections in data and lacks contextual awareness of data.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for generating a customer ontology for a business glossary. The method comprises: receiving a data schema from a customer environment, the data schema including a plurality of semantic elements; detecting a group of semantic elements in the plurality of semantic elements, the group corresponding to a unique element; generating, for each unique element, a node in the customer ontology; parsing a query received from the customer environment, the query including a first element and a second element; determining a relationship between the first element and the second element based on the query; and generating a vertex in the customer ontology between a first node representing the first element and a second node representing the second element, based on the determined relationship.

Certain embodiments disclosed herein also include a non-transitory computer readable medium having stored thereon causing a processing circuitry to execute a process, the process comprising: receiving a data schema from a customer environment, the data schema including a plurality of semantic elements; detecting a group of semantic elements in the plurality of semantic elements, the group corresponding to a unique element; generating, for each unique element, a node in the customer ontology; parsing a query received from the customer environment, the query including a first element and a second element; determining a relationship between the first element and the second element based on the query; and generating a vertex in the customer ontology between a first node representing the first element and a second node representing the second element, based on the determined relationship.

Certain embodiments disclosed herein also include a system for generating a customer ontology for a business glossary. The system comprises: a processing circuitry; and a memory, the memory containing instructions that, when executed by the processing circuitry, configure the system to: receive a data schema from a customer environment, the data schema including a plurality of semantic elements; detect a group of semantic elements in the plurality of semantic elements, the group corresponding to a unique element; generate, for each unique element, a node in the customer ontology; parsing a query received from the customer environment, the query including a first element and a second element; determine a relationship between the first element and the second element based on the query; and generate a vertex in the customer ontology between a first node representing the first element and a second node representing the second element, based on the determined relationship.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic illustration of a customer ontology generation, implemented in accordance with an embodiment.

FIG. 2 is a flowchart of a method for generating a customer ontology, implemented in accordance with an embodiment.

FIG. 3 is a schematic illustration of a graph of a customer ontology, implemented in accordance with an embodiment.

FIG. 4 is a schematic illustration of a global business data ontology connected to a customer ontology generator, implemented in accordance with an embodiment.

FIG. 5 is a flowchart of a method for generating a global ontology, implemented in accordance with an embodiment.

FIG. 6 is a flowchart of a method for performing ontology matching between a global ontology and a customer ontology, implemented in accordance with an embodiment.

FIG. 7 is a flowchart for generating a visual output from a customer business glossary application built upon a customer ontology, implemented in accordance with an embodiment.

FIG. 8 is a visual output generated using a customer business glossary application, implemented in accordance with an embodiment.

FIG. 9 is a schematic diagram of a customer ontology generator, implemented according to an embodiment.

FIG. 10 is a schematic illustration of a customer ontology, implemented in accordance with an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for generating a semantic layer over a plurality of datasets and providing a business glossary utilizing the semantic layer. In an embodiment the business glossary may be generated based on the semantic layer. In certain embodiments, a universal graph may be used to generate the business glossary, the semantic layer, or both.

In this regard, it is recognized that building a business glossary is a process performed by human operators, also referred to as users. However, this process is flawed, lengthy, tedious, and most importantly is often performed in an inconsistent manner. In order to be effective, a business glossary must be applied consistently, so that when a term is used to describe certain data, it is always used in the context of a specific data (or data source, or data type) in an injective manner. Users often fail at this task, as the same data can mean different things to different users, thus resulting in a confusion of definition. Therefore, when a user defines a term to describe data, the term may be used by another user to describe different data, or both the data and the different data, leading again to confusion and to inconsistencies.

The present disclosure is able to overcome this deficiency, for example by applying objective criteria when defining a business glossary using a semantic layer. By generating for each data set a semantic layer based on a universal model (i.e., a model which is applied across different data sets based on a single data schema) using, for example, natural language processing (NLP) techniques, an objective criteria is applied to the data when cataloging it, which leads to a consistent result, thus making the business glossary reliable and therefore useful.

In an embodiment, a system generates local ontology, also referred to as a customer ontology, based on a global ontology. The local ontology, i.e. customer ontology, is local in the sense that it applies to a single entity (e.g., organization) which is serviced by the global ontology. In an embodiment the global ontology is defined across various industries, services, segments, and the like, each of which may have different terms. In an embodiment a customer ontology is used to generate a business glossary with which a user may increase operational efficiency, gain additional insights from large data sets, and other competitive advantages.

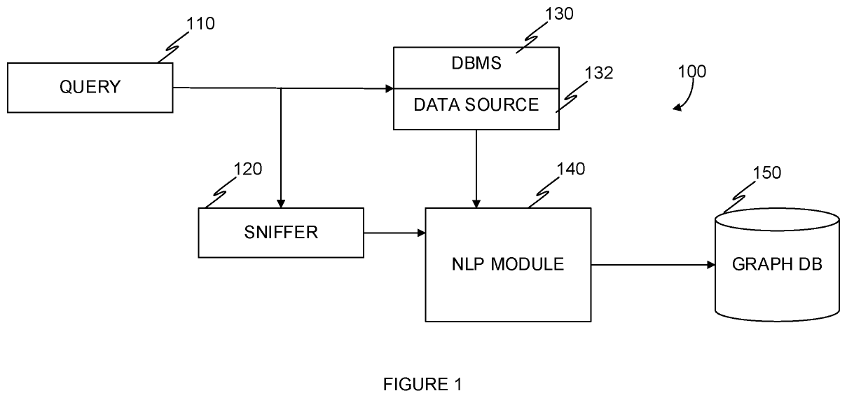

FIG. 1 is a schematic illustration 100 of a customer ontology generation, implemented in accordance with an embodiment. A user using a computing device, such as a personal computer, generates queries, such as query 110, directed at a data source 132. A data source 132 is, for example, a structured data source such as a repository of data, e.g., a data lake, data warehouse, OLAP, OLTP, graph database, and the like.

In an embodiment, the data source 132 includes a database management system (DBMS) 130, which is used to access the data source 132. The DBMS 130 is configured to received queries for execution on a data set of the data source 132. A result is generated based on execution of the query 110, which may then be provided to the user (directed at a user device or user account). For example, when a business intelligence (BI) report refreshes and loads new data to dashboards, widgets, and the like, queries are generated, for example by a BI system (not shown) to generate results which are used to display metrics of the report. A BI system may describe a software tool, or suite of software tools, which provides, for example, predictive modeling, data mining, contextual dashboards, key performance indicators (KPIs), and the like, in an attempt to transform complex, often large, datasets into insights and actionable decisions.

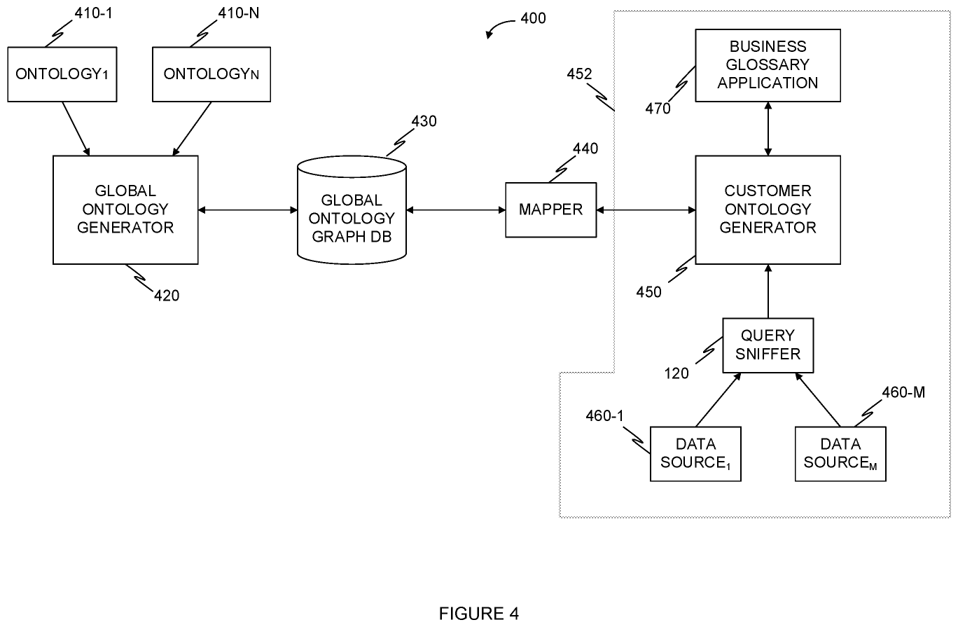

In an embodiment, an ontology generator (discussed in more detail in FIG. 4 below), includes a query sniffer 120. In certain embodiments the query sniffer 120 is implemented as a module (e.g., a microservice) that is deployed on: a user device (e.g., where an analytic application generates the query); a system of the data source 132, both, or in a cloud computing environment (not shown). In an embodiment the query sniffer 120 is configured to detect queries at application-level, which are directed at the DBMS 130. In an embodiment the query sniffer 120 is deployed in a communication line between the user device and the data source 132 at which a query 110 is directed. For example, in an embodiment a query sniffer 120 is configured to receive queries which are generated by a user device and directed to a data set stored in a Snowflake® data warehouse (or another SQL-based data source).

In an embodiment the query sniffer 120 is further configured to provide the query 110 to a Graph and natural language processing (NLP) module 140. In an embodiment the graph and NLP module 140 is implemented as a microservice, for example deployed in a cloud computing environment. In certain embodiments, the DBMS 130 is configured to send the queries to the Graph and NLP module 140.

In an embodiment the Graph and NLP module 140 is configured to extract entities, metrics, and the like, from a corpus of queries (i.e., a plurality of queries). In some embodiments, an entity is a metric, term, KPI, and the like which a business (i.e., a customer), wishes to track, and may be connected to applications, users, queries, directed acyclic graph (DAG) jobs, notebooks, columns, tables, schemas, data sources tables, columns, aliases, formulas, dimensions, filters, values, combinations thereof, and the like.

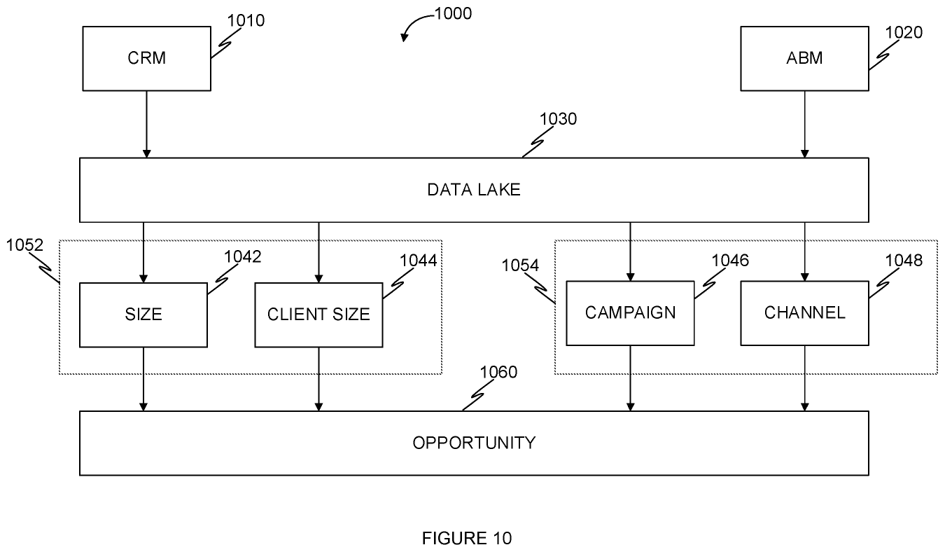

In an embodiment the Graph and NLP module 140 is configured to group entities based on NLP techniques, such as synonym detection, proximity detection, formula pattern detection, a combination thereof, and the like. In certain embodiments the Graph and NLP module 140 is configured to generate nodes based on the extracted entities metrics, and the like, and further generate vertices based on grouping. The Graph and NLP module 140 is configured, in an embodiment, to store the nodes and vertices in a graph database 150 as a customer ontology, from which a local business glossary may be generated. In an embodiment an entity group is stored in the graph database as part of the customer ontology. An entity group may represent, for example, a term, such as discussed in more detail in FIG. 10 below.

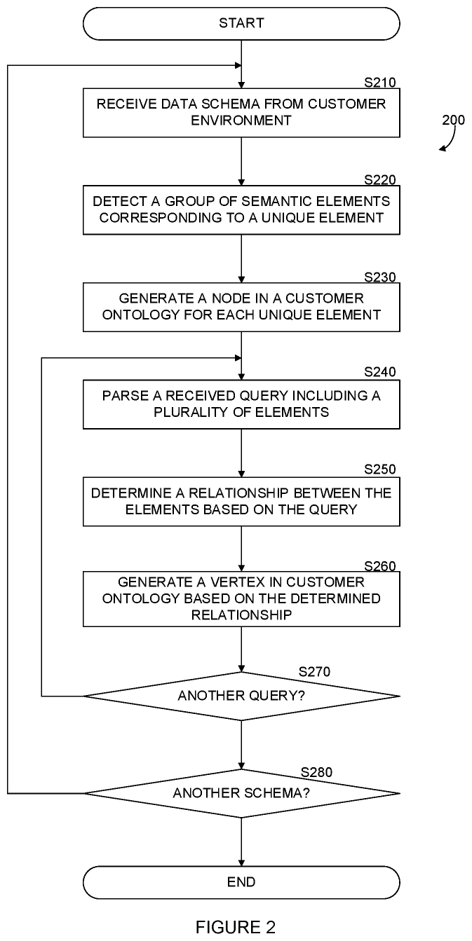

FIG. 2 is an example flowchart 200 of a method for generating a customer ontology, implemented in accordance with an embodiment. In an embodiment, the customer ontology is used to generate a business glossary for the customer. A customer may be a user, group of users, and the like, attached to a business entity (e.g., organization) which utilizes multiple data sources.

At S210, a data schema is received. In an embodiment, a data schema includes a set of formulas, constraints, and the like which are imposed on a structured data, such as a relational database. In an embodiment the formulas, constraints, and the like are expressed in a formal language of a database management system (DBMS). In an embodiment, the data schema may include semantic elements. For example, a semantic element may be metadata, such as a column name, column type, and the like. In certain embodiments, a plurality of data schemas are received. A data schema is received from a customer environment. In an embodiment a customer environment includes data sources, data lakes, databases, and the like structured data. In some embodiments, a customer environment includes data sources for example, which are stored on premises (on-prem), in a private cloud (e.g., virtual private cloud), public cloud, a combination thereof, and the like. For example, a customer environment may include a first database having a first schema installed on an on-prem server, and a second database having a second schema deployed through a software as a service (SaaS) provider, such as a data warehouse (e.g., Snowflake®) which stores data from a Salesforce® account.

At S220, a group of semantic elements which all correspond to a unique element are detected. In an embodiment, a natural language processing technique may be utilized to detect a group of semantic elements from a data schema. For example, in a data schema may describe a plurality of tables stored in a relational database. A first table includes a column named “user”, a second table includes a column named “usr_nm”, and a third table includes a column named “member name”. In an embodiment, an NLP technique may be used to determine that each of these columns refers to the same unique element, which is an identity. In some embodiments, an input may be received which is used to confirm that the NLP technique correctly mapped metadata from the data schema to a unique element.

At S230, a node is generated in a customer ontology for each unique element. In an embodiment, a customer ontology is implemented as a graph stored on a graph database. The graph includes nodes, at least a portion of which represent unique elements of a data schema. The graph further includes vertices, which represent each a relationship between elements represented by the corresponding nodes connected with the vertex. For example, Neo4j™ is a graph database on which a customer ontology may be stored as a graph.

At S240, a received query is parsed. In certain embodiments, a plurality of queries are parsed. In an embodiment received queries are directed to a data set, data store, data warehouse, database, and the like, of which a schema was received. For example, the data set may be stored on a Snowflake® data warehouse. In an embodiment, a query includes an entity, an element, and the like. In an embodiment entities are metrics, attributes, terms, measures, and the like, which a business (i.e., a group of users, also referred to throughout as a customer) aims to track, which are connected to applications, users (e.g. user accounts), queries, DAG jobs, notebooks, columns, tables, schemas, data sources tables, columns, aliases, formulas, dimensions, filters, values, combinations thereof, and the like. In an embodiment a query may include a plurality of entities, a plurality of metrics, and any combination thereof. In an embodiment, parsing a query includes performing a semantic check on the query. A semantic check on a query may be performed to identify data elements in the query. In an embodiment, a syntax check may be performed to determine that the query syntax is correct.

At S250, a relationship is determined between a first element and a second element from the parsed query. In certain embodiments, a relationship may be for example, parent-child, where a first element is a parent of a second element, making the second element a child of the first element. In other embodiments, a relationship indicates, for example, a first element is a filter of the second element.

At S260, a vertex is generated in the customer ontology based on the determined relationship. In an embodiment, generating a vertex further includes matching the first element and the second element to a node in the customer ontology. Each node in the customer ontology represents a unique element, all of which are detected from data schemas of the customer environment. Therefore, each query element received from the customer environment should be represented by a unique node in the environment. In some embodiments, a global ontology is accessed to generate a vertex. In an embodiment, a node representing the first element is matched to a first node in the global ontology, and a node representing the second element is matched to a second node in the global ontology. A check may be performed to determine if the first node and the second node in the global ontology are connected with vertices, and if they are connected for example with a vertex, generate a corresponding vertex in the customer ontology.

In certain embodiments, the vertices may indicate two entities appearing together in a query, used as a compound variable or in a formula, used by certain applications, have close NLP proximity score, were used in the same context, one node being an attribute of another, and the like. An NLP proximity score may be determined, for example, using a Word2Vec process. In an embodiment, a proximity score determines, for a pair of words (or other string) a distance between the words. For example, a low score may indicate that the words are distant, while a high score indicates that the words are proximate. A word may be proximate to another word based on, for example, context, phonetic sound, combinations thereof, and the like.

At S270, a check is performed to determine if another query should be parsed. In certain embodiments, a plurality of queries are received, and may be processed serially, in parallel, or a combination thereof, to generate vertices in the customer ontology. If an additional query should be processed execution continues at S240. In an embodiment, if no additional queries should be processed, execution may continue at S280. In some embodiments, if no additional queries should be processed, execution may loop to S270, where another check is performed to determine at a later time if another query should be processed. In some embodiments, a loop may be executed a predetermined number of times.

At S280, a check is performed to determine if another schema should be processed from the customer environment. In an embodiment, if yes execution continues at S210, otherwise execution terminates. In some embodiments, if no execution may continue at S270. In some embodiments, an optional check may be performed to determine if another group of semantic elements should be detected from which a node corresponding to a unique element is generated. In such embodiments, if yes execution continues at S220. If no execution may continue at S260, S270, or terminate.

In certain embodiments, the customer ontology may be updated continuously by generating new nodes, new vertices, updating existing nodes, updating existing vertices, and any combination thereof, as new queries are received, periodically, or a combination thereof; and by incorporating the user interaction with a business glossary which is generated based on the customer ontology.

In an embodiment an enrichment mapping service is configured to update the customer ontology (i.e., the stored graph) based on a global ontology (See, e.g., FIG. 4).

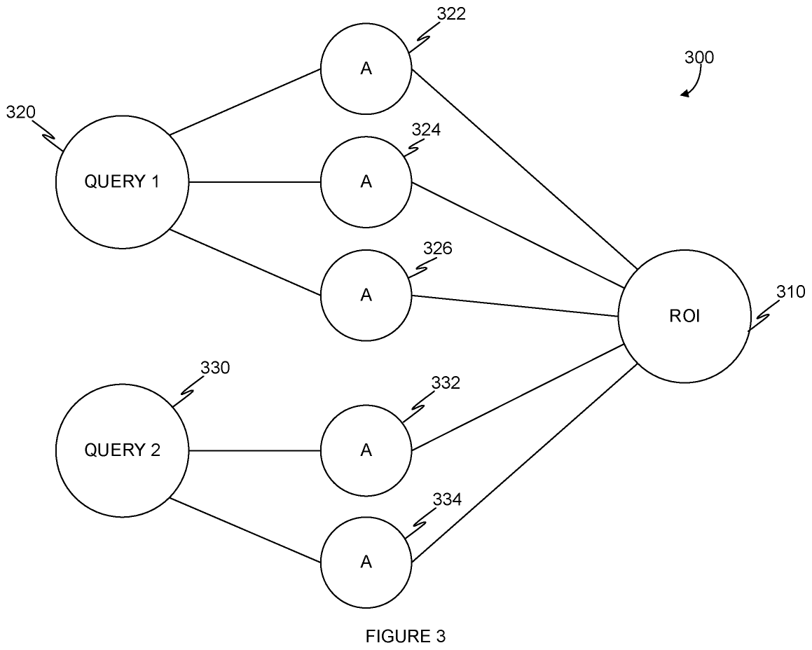

FIG. 3 is an example of a schematic illustration of a graph 300 of a customer ontology, implemented in accordance with an embodiment. The graph 300 includes a first query node 320 and a second query node 330. Two query nodes are presented here merely for simplicity, and it should be understood that a customer ontology graph may store a larger plurality of nodes.

In an embodiment, a query node represents a unique query. In certain embodiments, each unique query is parsed, for example by a Graph and NLP module, to extract query terms, metrics, attributes, and the like such as first attribute 322, second attribute 324, and third attribute 326, all extracted from a first query which corresponds to first query node 320.

In an embodiment, a Graph and NLP module is configured to further group attributes, metrics, and the like, by mapping them to term nodes, such as a key performance indicator (KPI) nodes. For example, attributes 322 through 326 and attributes 332 and 334 are all mapped (i.e., connected by a vertex) to return on investment (ROI) node 310, where ROI is a type of KPI which is monitored. In an embodiment, nodes representing terms, metrics, attributes and the like, correspond to a logic (i.e., a set of queries) which is executed to determine an ROI metric. In an embodiment, the logic includes a first query represented by the first query node and a second query represented by the second query node 330.

A user of the business glossary application, which is implemented on top of the customer ontology, may, therefore, search for a logical term (such as KPI) and receive as an output “ROI”, which is connected to a query or queries that correspond to the logical term. This allows a user to utilize their data source by receiving query suggestions simply by indicating what the user is interested in learning about. This process of data exploration allows a user to gain additional insight from their data, without requiring the user to have a priori knowledge of what they are searching for.

FIG. 4 is an example of a schematic illustration 400 of a global business data ontology connected to a customer ontology generator, implemented in accordance with an embodiment. In an embodiment a plurality of public ontologies 410-1 through 410-N, generally referenced as ontologies 410, or individually as ontology 410, where ‘N’ is an integer having a value of ‘2’ or greater are connected, for example via a network, to a global ontology generator 420. In an embodiment the public ontologies 140 may be each deployed on a workload in a cloud computing environment, for example on a virtual machine or container. In some embodiments a public ontology 410 may be stored on a graph database, which is deployed on a workload. In an embodiment the public ontologies 410 are communicatively connected to a network. In an embodiment, a graph database 430 may be deployed on a virtual machine, which in turn is connected to the network. The graph database is utilized to store

In an embodiment, the network may be configured to provide connectivity of various sorts, as may be necessary, including but not limited to, wired and/or wireless connectivity, including, for example, local area network (LAN), wide area network (WAN), metro area network (MAN), worldwide web (WWW), Internet, and any combination thereof, as well as cellular connectivity.

In certain embodiments, the network further provides connectivity to a mapping and enrichment service 430. In an embodiment the mapping and enrichment service (also referred to as a mapper) 430 is communicatively coupled via the network with a global ontology graph database 440. The global ontology stored on the graph database 440 may be updated with a plurality of customer ontologies, such as customer ontology 450, public ontologies 410, and the like, so as to include nodes and vertices from multiple public ontologies 410, industry taxonomies, public data sources, such as data exchanges, data schemas, and the like. The global ontology is an embedding of multiple public ontologies and public taxonomies and is useful for generating and enriching where there is an initial draft customer ontology, for example, or bootstrapping a customer ontology where there are no queries in a customer environment.

For example, when deploying a new customer ontology, a scan may be initiated for existing queries and schemas in a customer environment 452. In certain embodiments the customer environment 452 is implemented as a cloud computing environment, implemented for example as a virtual private cloud (VPC) in a cloud computing infrastructure, such as Amazon® Web Services (AWS), Google® Cloud Platform, and Microsoft® Azure.

In an embodiment the customer environment includes workloads (e.g., virtual machines, containers, and the like) which encompass schemas, queries, and the like, from unstructured data, structured data, data warehouses, data lakes, columnar databases, tables, columns, data sets, OLAP cubes, graph databases, BI systems, user access management systems, user devices, combinations thereof, and the like. In certain embodiments the client environment may include a local environment (such as a VPC), and a third party environment, for example providing software as a service (SaaS) to the local environment.

For example, the client environment 452 includes, in an embodiment, a plurality of data sources 460-1 through 460-M, generally referenced as data sources 460 and individually referenced as data source 460, where ‘M’ is an integer having a value of ‘2’ or greater. In an embodiment, a data source 460 may be implemented on a workload in a cloud computing environment. A data source 460 may be, for example, a customer relationship management (CRM) system, such as Salesforce®, a data lake, such as Snowflake®, and the like. In an embodiment, a data source 460 includes structured data, semi-structured data, unstructured data, binary data, combinations thereof, and the like.

Structured data is, for example, a relational database, a graph database, an array, a table, a linked list, a stack, and the like. Semi-structured data is, for example, comma-separated values (CSV) files, logs, XML files, JSON files, and the like. Unstructured data includes, for example, emails, document files, post script files, and the like. Binary data includes, for example, image files, video files, audio files, and the like.

In an embodiment, each data source 460 of the customer environment 452 is mapped to a metric, KPI, term, attribute, and the like, of the global ontology. In certain embodiments, a mapper 440 is configured to perform mapping of the metric, KPI, term, attribute, and the like.

In certain embodiments, a customer ontology generator 450 is configured to generate a graph (i.e., customer ontology) including nodes and vertices. Each node represents, for example, a data source, a term, an attribute, a metric, a KPI, a logical element, a workload of the customer environment, a user, a user account, a user identifier, and the like. A vertex in the graph represents a connection between nodes. In an embodiment, a vertex is generated based on a detected connection, for example based on a predefined data schema, such as from a public ontology 410. In some embodiments, the customer ontology generator 450 is configured to generate nodes in a customer ontology based on, or based on a portion of, a global ontology. For example, a term detected in the customer environment 452 may be mapped, for example by a mapper 440 configured to perform NLP techniques on the term, to a node in a global ontology stored on the global ontology database. In an embodiment detecting a term in the customer environment 452 includes receiving a query by a query sniffer 120, and parsing the query to detect elements therein. A term may be detected from a query element, for example.

Utilizing a global ontology to deploy a customer ontology is faster and more precise than building a logical semantic layer from scratch with no prior knowledge. In some instances, building a logical semantic layer (i.e., an unpopulated customer ontology) may not be possible without a large enough body of queries from which to draw.

In this regard, it is noted that in some embodiments, the generated customer ontology may contain errors, for example by mismatching a term to the correct business glossary context. However, any cost of errors is outweighed by the speed at which the new business glossary is deployed, which allows users to access data in a quicker way, providing data exploration capabilities, as well as the ability to correct an already function model (e.g., by providing user input, also known as a certification flow), which is faster than building a model from scratch. All this thereby increases the benefit of having such data.

Furthermore, in certain embodiments a customer ontology generator is configured to receive an input from a user to tag a match, in order to indicate that the match is correct. In certain embodiments, a user account is tagged, or otherwise marked, as an expert account for a particular domain, field of endeavor, industry, and the like. In an embodiment, the customer ontology generator is configured to request an input from a user of an expert account, in response to determining that a term of the match is semantically similar, within a predetermined threshold, to the domain, field of endeavor, and the like, of the expert account. For example, a first term is detected from a data source 460 or from a parsed query received by the query sniffer 120. The customer ontology generator 450 is configured to store the first term in a corresponding node in a customer ontology. The corresponding node may be determined to be corresponding by a mapper 440, which detects a node in a global ontology that matches the term. In an embodiment the node may be marked by default as unverified, uncertified, etc. to indicate that while it is assumed to be a correct matching between the detected term and the node, a user has not provided an input to verify this. In certain embodiments, a node to term matching is updated, for example with a tag, after a predetermined period of time has passed. In other embodiments, a node to term matching is updated with a tag in response to receiving an input from a user, indicating that the term does indeed match with the node in the customer ontology.

In some embodiments, a logical element may be displayed to a user together with an indicator of the workload in order to receive an input from the user to confirm or deny the mapping. A user may override the mapping by either indicating that the workload does not match the logical element or by indicating that the workload should be connected to a different logical element than the mapped logical element. This allows to incorporate user feedback into a customer ranking system, for the customer ontology and also add an information layer (i.e. semantic layer) to the global ontology. In an embodiment, the customer ranking system includes weights which are assigned to vertices of the graph representing the customer ontology.

In some embodiments a customer ontology generator 450 may periodically perform a check with a global ontology graph store 430, to determine if new nodes or vertices are available to add to the customer ontology. In some embodiments, the customer ontology generator 450 may request delta nodes, i.e., nodes which do not appear in the customer ontology graph, but appear in the global ontology graph.

Delta nodes may be connected to nodes that do appear in the customer ontology. In an embodiment, a delta node is further connected by a delta vertex to a node which is present in the customer ontology. The delta vertex may be generated in the customer ontology in response to generating the delta node. By requesting only the delta nodes communication bandwidth is saved since duplicated data that already exists on the local ontology is not downloaded over the network. In an embodiment the enrichment mapping service may run continuously as both local and global ontologies may be constantly changing.

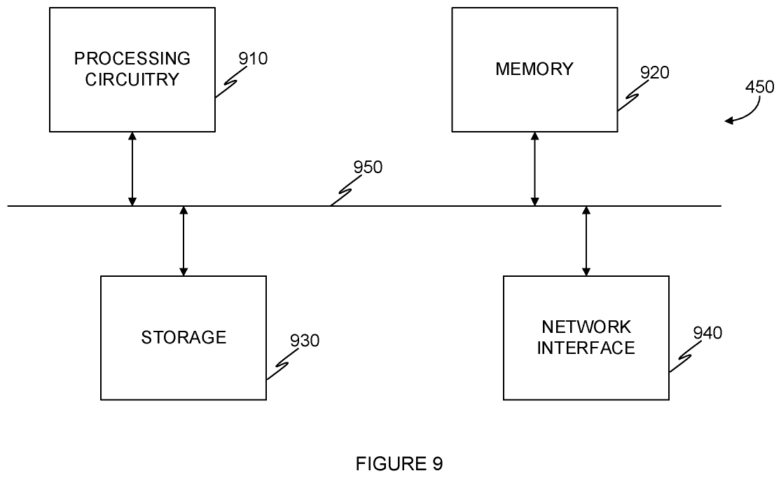

While this example shows public ontologies, a global ontology, and a business glossary application deployed on different workloads, it should be evident that these may be executed on a single machine, multiple machines, or combinations thereof, without departing from the scope of this disclosure, where a machine is a physical or virtual computing device capable of executing software, code, microinstructions, combinations thereof, and the like. An example of a customer ontology generator 450 is discussed in more detail in FIG. 9 below.

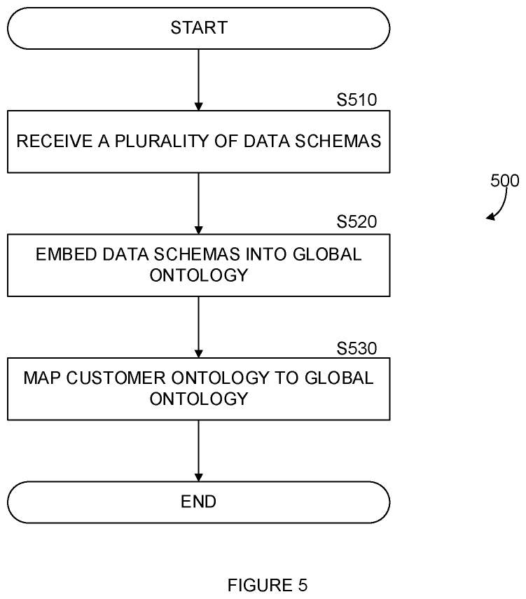

FIG. 5 is an example of a flowchart 500 of a method for generating a global ontology, implemented in accordance with an embodiment. In an embodiment, a global ontology is implemented as a graph, stored on a graph database.

At S510, a plurality of data schemas are received. In an embodiment, a data schema is an industry taxonomy, a customer ontology, a public data exchange schema, and the like. Each data schema is a data structure which includes a term, each term having at least an attribute. An attribute is a data field which may receive a value. In an embodiment, a data schema may be stored as a graph, for example in a graph database.

At S520, the received data schemas are embedded into a global ontology. In an embodiment, embedding the data schemas into a global ontology includes generating a semantic layer. The semantic layer may be implemented, for example, as a graph where terms of a data schema are represented as nodes in the graph. In certain embodiments, an attribute may be represented as a node in the graph, for example connected by a vertex to a node representing a term. In certain embodiments, a node may be generated based on a term, for example by performing natural language processing on the term to determine if a node should be generated for the term, or if the term is already represented in the semantic layer by another node.

At S530, a customer ontology is mapped to the global ontology. In an embodiment, a node, a vertex, combinations thereof, and the like, are mapped to a corresponding node, vertex, and the like of the global ontology. In an embodiment, mapping the customer ontology to the global ontology may include any one of: proximity detection to determine a distance between a node of the customer ontology and a node of the global ontology, proximity detection to determine a distance between a vertex of the customer ontology and a vertex of the global ontology, graph subcluster matching techniques, and the like.

In an embodiment, there may be no overlap between the customer ontology and the global ontology. For example, overlap may be determined by a number of matching nodes, a number of matching vertices, and the like. In an embodiment the number of matching nodes, for example, may be predetermined. For example, if less than 1 node matches occur, the graphs (i.e., customer ontology and global ontology) are determined to have no overlap.

In certain embodiments, where there is no overlap between the customer ontology and the global ontology, the customer ontology may be added to the global ontology by adding a node, a vertex, a vertex weight, and the like which does not appear in the global ontology, from the customer ontology to the global ontology.

In some embodiments partial overlap may exist between the customer ontology and the global ontology. In certain embodiments, partial overlap is determined by a number of matching nodes, a number of matching vertices, and the like. In an embodiment the number of matching nodes, for example, is predetermined. For example, if less than 10 node matches occur, but more than 1, the graphs (i.e., customer ontology and global ontology) are determined to have partial overlap. Nodes which do not overlap (i.e., are present in the customer ontology but not in the global ontology) are added from the customer ontology to the global ontology. In an embodiment the overlapping nodes and vertices from the customer ontology are used to update a ranking of corresponding nodes and vertices in the global ontology.

In an embodiment where there is at least a partial match between the local and global ontologies (i.e., all nodes of the local ontology are represented in the global ontology), the global ontology is updated with ranks, weights, and the like, of vertices. For example, where a vertex exists between a pair of nodes in the local ontology and the global ontology, a weight of the vertex is increased to reflect that this connection is present. In an embodiment, where a vertex does not exist between a pair of nodes, but does exist in the global ontology between the pair of nodes, a weight of the vertex in the global ontology is decreased to reflect this connection is not present. This is advantageous to update the global ontology according to actual use cases of real data, and not just relying on a theoretical data model. Thus the accuracy of the global ontology as a data model is increased.

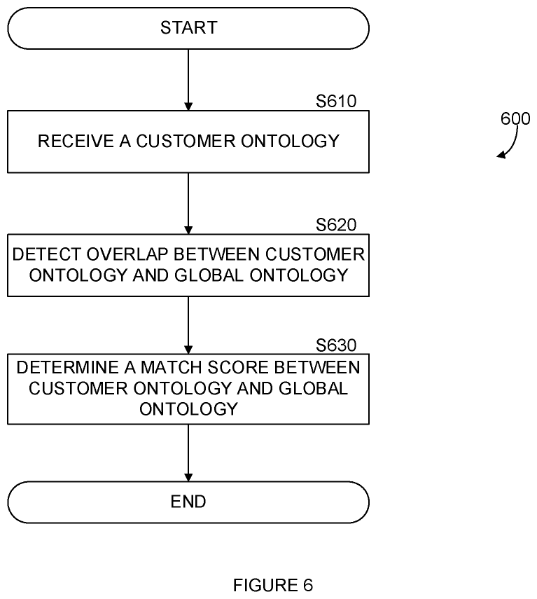

FIG. 6 is an example of a flowchart 600 of a method for performing ontology matching between a global ontology and a customer ontology, implemented in accordance with an embodiment.

At S610, a customer ontology is received. In an embodiment, the customer ontology is implemented as a graph, stored for example on a graph database. The customer ontology includes a plurality of nodes representing logical elements such as terms, attributes, KPIs, metrics, and the like, and queries, query parts, and the like, and vertices connecting the nodes to each other. In certain embodiments a customer ontology is received periodically; in other embodiments, only new nodes and vertices (i.e., delta nodes and delta vertices) which were not received previously are received.

At S620, an overlap is detected between the customer ontology and a global ontology. In an embodiment detecting an overlap includes determining that a first node in the customer ontology corresponds to a first node in the global ontology. In some embodiments, a confidence score may be assigned to an overlap. An overlap and confidence score may be generated, for example, by utilizing natural language processing techniques. For example, a node in a customer ontology is associated with a first term, and a node in the global ontology is associated with a second term. NLP may be utilized to determine a distance between the first term and the second term. In an embodiment, a threshold is predetermined, such that where the distance is below the threshold, the first term and second term are considered a match.

At S630, a match score is determined between the customer ontology and the global ontology. In an embodiment the match score is further determined based on the detected overlap. In an embodiment, by utilizing NLP techniques, for example, an accurate match score is determined, since even if terms are not an exact string match, the context in which they are used does generate a match, thereby allowing to accurately map a customer ontology to a global ontology (and vice versa). This decreases redundant nodes in the global ontology which allows for a smaller model which is more accurate. When redundant nodes exist, some terms may be mapped to one node but not the other, thereby creating confusion as only a single node should exist with all terms mapped to it.

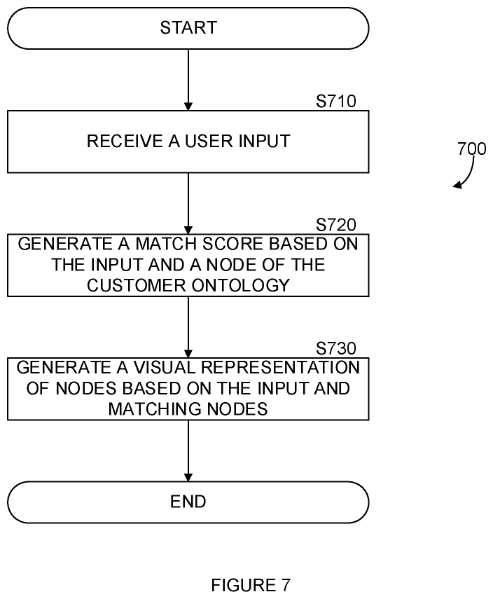

FIG. 7 is an example flowchart 700 for generating a visual output from a customer business glossary application built upon a customer ontology, implemented in accordance with an embodiment.

At S710 a user input is received. In an embodiment the user input is a textual input. In certain embodiments a textual input includes a string of alphanumeric characters. A user input may be received through a graphic user interface (GUI). In an embodiment, instructions for generating a GUI are supplied to a user device. For example, the GUI generation instructions may be downloaded from a server over a network connection. The GUI instructions, when executed by a client device, configure the client device to render the GUI which allows the client device to send a user generated input to a server on which a business glossary application is deployed.

At S720 a match score is generated based on the user input and a node of a customer ontology. In an embodiment, the match score is generated based on executing natural language processing techniques based on the user input, and a term, attribute, and the like, represented by the node of the customer ontology. In the example of FIG. 3, a user input of “return on” is matched to the ROI node 310. In an embodiment, a customer ontology is traversed to detect another node which is connected to the matched node. For example, the customer ontology is traversed to detect another node connected to the ROI node 310. Detecting additional nodes connected to the matched node allow, for example, to anticipate a user's intention and aid data exploration, by providing nodes, terms, attributes, and the like, which are likely to match what a user is searching for. The additional nodes represent relevant terms, for example, due to a connection between the matched node and an additional node, which is based on a vertex, vertex weight, and the like. For example, an additional node connected to the matched node with a vertex having a weight exceeding a predetermined threshold is determined to be closely related. In an embodiment, an additional node connected to the matched node with a vertex having a weight below a predetermined threshold is determined to not be related to the matched node. In an embodiment an additional node which is determined to not be related to the matched node is not provided for generating a visualization.

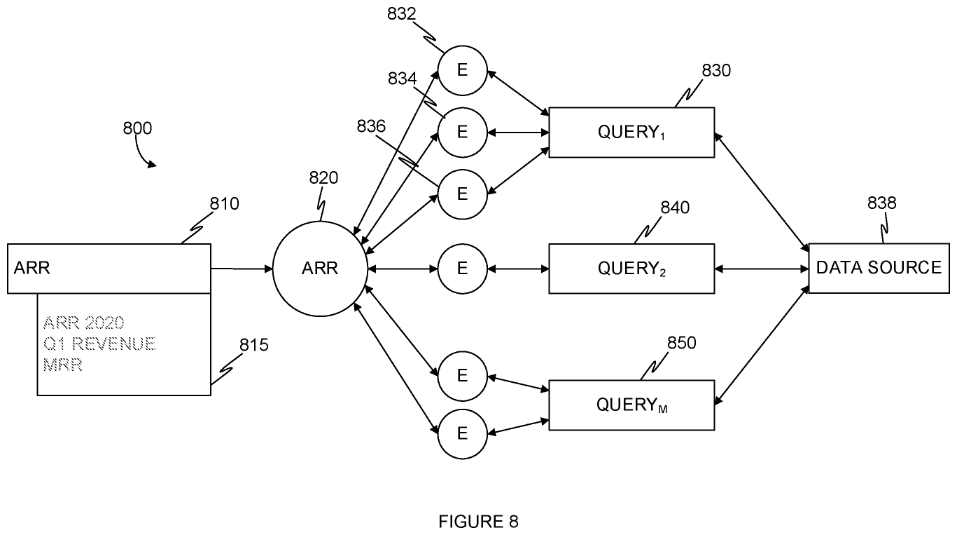

At S730, a visualization is generated based on the match and received input. In an embodiment the visualization includes the received user input, and a node having a match score which exceeds a predetermined threshold (e.g., a matched node). In certain embodiments the visualization includes a plurality of nodes having a match score which each exceeds the predetermined threshold. In some embodiments, the visualization is further generated based on another node which is connected to the matched node. In certain embodiments, the another node is connected with a vertex to the matched node, the vertex having a weight which exceeds a predetermined threshold. An example of a data visualization is discussed in more detail in FIG. 8 below.

FIG. 8 is an example of a visual output 800 generated using a customer business glossary application, implemented in accordance with an embodiment. In an embodiment, the customer business glossary application is generated based on a customer ontology. A textual user input 810 is received and matched to a node 820 of a customer ontology. In an embodiment, the customer ontology includes a plurality of nodes, however a single node is shown here merely for simplicity.

In certain embodiments, matching the textual user input 810 to the node 820 is performed utilizing NLP techniques, for example as discussed above. In some embodiments, a plurality of matches may be generated between the user input 810 and nodes of a customer ontology, such that each match corresponds to a single node. In certain embodiments, match suggestions are generated and displayed in a subsection 815. In an embodiment the subsection 815 is configured to render in a color which is less dominant (e.g., grey) than a color of the input field of the user input (e.g., black), to provide a visual indication that the subsection 815 provides suggestions.

In an embodiment, the suggestions in the subsection 815 are generated based on traversing the customer ontology and detecting a node which is matched to the textual user input 810. In another embodiment, the suggestions of the subsection 815 are generated based on traversing the customer ontology and detecting a node which is connected to the matched node (e.g., nodes which are connected to the matched node 820).

The textual user input 810 is matched with an node 820, representing annual recurring revenue (ARR). In this example the customer business glossary includes an ARR node 820 connected with a plurality of elements, such as first element 832, second element 834, and third element 826 of a first query node 830. In an embodiment, an element is a term, attribute, and the like. In certain embodiments an element is, for example, an entity node, a metric node, and the like.

A first query node 830, a second query node 840, and a third query node 850 (each with their respective element nodes, and each representing a respective unique query) are connected to a data source 838. Each query node represents a query, and each element node represents an entity extracted from the query. A query node may be connected to a resource node. In this example, the first query node 830 is connected to a data source node 838, for example. Such a connection indicates that the first query represented by the first node 830 is intended to be executed on a data source represented by the data resource node 838.

The visual output 800 provides certain advantages in utilizing a business glossary. For example, a user who is interested in exploring data related to ARR (annual recurring revenue) may discover metrics, entities, queries, and the like, of which they would not have been otherwise aware. New queries, for example, allow gaining insight from existing data, increasing its value to a user.

Furthermore, by providing a user with alternative logical entities, such as the suggestions in subsection 815, a user is able to discover additional data which is related to their search term (i.e., the user input 810). For example, the user may be suggested to also explore MRR (monthly recurring revenue), or other additional fields which the user had not intended to do. By providing these suggestions the user is able to take better advantage of their existing data, thereby increasing its value.

The customer ontology generator, Graph and NLP module, or both may be executed on a workload in a cloud computing environment, or on a dedicated computing system, as another example. Such a system is discussed in more detail in FIG. 9 below.

FIG. 9 is an example schematic diagram of a customer ontology generator 450, implemented according to an embodiment. The customer ontology generator 450 includes a processing circuitry 910 coupled to a memory 920, a storage 930, and a network interface 940. In an embodiment, the components of the customer ontology generator 450 are communicatively connected via a bus 950.

The processing circuitry 910 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 920 may be volatile (e.g., random access memory, etc.), non-volatile (e.g., read only memory, flash memory, etc.), or a combination thereof.

In one configuration, software for implementing one or more embodiments disclosed herein may be stored in the storage 930. In another configuration, the memory 920 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 910, cause the processing circuitry 910 to perform the various processes described herein.

The storage 930 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 940 allows the customer ontology generator 450 to communicate with, for example, a mapper 440, query sniffer 120, business glossary application 470, and the like.

It should be understood that the embodiments described herein are not limited to the specific architecture illustrated in FIG. 9, and other architectures may be equally used without departing from the scope of the disclosed embodiments. Furthermore, additional workloads discussed herein, such as the global ontology generator 420, mapper 440, query sniffer 120, customer business glossary, and the like, may be deployed on a system having an architecture such as described in FIG. 9, or an architecture equal to the architecture described above.

FIG. 10 is an example schematic illustration 1000 of a customer ontology, implemented in accordance with an embodiment. A customer ontology is a graph structure unique to a customer, which is a user, or group of users, having for example user accounts, which are part of a single organization. An organization can use many different software services, each generating data. For example, an organization may utilize a CRM system 1010 which provides sales services and generates sales-related data. A CRM system 1010 may be provided, for example, by Salesforce®, which provides CRM software as a service (SaaS). An organization may also utilize an account-based marketing (ABM) system 1020 which provides marketing services and generates marketing related data. An ABM system 1020 such as Marketo® may provide such solutions, for example.

Data generated by each of the CRM system 1010 and the ABM system 1020 is stored in a data lake. In an embodiment, a data lake stores structured data, unstructured data, semi-structured data, binary data, a combination thereof, and the like. Structured data is, for example, a relational database, a graph database, an array, a table, a linked list, a stack, and the like. Semi-structured data is, for example, comma-separated values (CSV) files, logs, XML files, JSON files, and the like. Unstructured data includes, for example, emails, document files, post script files, and the like. Binary data includes, for example, image files, video files, audio files, and the like.

In an embodiment, data terms are matched to data from the data lake. For example, in an embodiment a sales data schema 1052 includes a first data attribute 1042 representing “size” (i.e., how big a sales contract is, in currency value), and a second attribute 1044 representing “client size” (i.e., how big a client is, has the potential to be, etc., in terms of income). In another embodiment, a marketing data schema 1054 includes a third data attribute 1046 representing “campaign” (e.g., an activity to promote an objective.) and a fourth data attribute 1048 representing “channel” (e.g., social media, television, radio, etc.).

In this regard, it is noted that sales and marketing, while two different fields of endeavor, often use similar terms, such as “opportunity”. However, a sales opportunity is not always a marketing opportunity, and vice versa. In an embodiment, the customer ontology includes the first data attribute 1042, the second data attribute 1044, the third data attribute 1046 and fourth data attribute 1048, each of which is represented as a node in the customer ontology. In certain embodiments the customer ontology further includes a marketing node to represent the marketing data schema 1054, and a sales node to represent the sales data schema 1052. In some embodiments, nodes representing each of the first data attribute 1042, the second data attribute 1044, the third data attribute 1046 and fourth data attribute 1048 are connected to a term node 1060 representing “opportunity”.

Thus, each term is represented once in the customer ontology as a unique node, and is connected to different attributes based on a context, which is provided by a relevant data schema.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for generating a customer ontology for a business glossary, comprising:
receiving a data schema from a customer environment, the data schema including a plurality of semantic elements;
detecting a group of semantic elements in the plurality of semantic elements, the group corresponding to a unique element;
generating, for each unique element, a node in the customer ontology;
parsing a query received from the customer environment, the query including a first element and a second element;
determining a relationship between the first element and the second element based on the query; and
generating a vertex in the customer ontology between a first node representing the first element and a second node representing the second element, based on the determined relationship.

2. The method of claim 1, further comprising:
detecting an overlap between the customer ontology and a global ontology, the overlap including: a first node of the global ontology corresponding to the first node of the customer ontology, and a second node of the global ontology corresponding to another node of the customer ontology, wherein the first node of the customer ontology is not connected to the another node, and the first node of the global ontology is connected by a first vertex to the second node of the global ontology; and
generating a second vertex, based on the first vertex, in the customer ontology, the second vertex connecting the first node of the customer ontology to the another node.

3. The method of claim 2, further comprising:
detecting an expert user account, the expert user account associated with a data source linked to the another node; and
sending the expert user account a request to confirm that the another node is correctly linked to the data source.

4. The method of claim 3, further comprising:
sending the expert user account a request to confirm that the second vertex should connect the first node of the customer ontology to the another node.

5. The method of claim 4, further comprising:
deleting the second vertex from the customer ontology in response to receiving an instruction from the expert user account; and
generating a tag associated with the second vertex to indicate a verified connection, in response to receiving a confirmation from the expert user account.

6. The method of claim 3, further comprising:
deleting a vertex connecting a data node representing the data source to the another node, in response to receiving a response from the expert user account that the another node is not correctly linked to the data source; and
generating a tag associated with the vertex connecting the data node to the another node, in response to receiving a confirmation from the expert user account.

7. The method of claim 1, further comprising:
receiving a user generated input, the input including a string;
detecting a node in the customer ontology which matches the string, the node including data; and
sending the node data to a user device from which the user generated input was received.

8. The method of claim 7, further comprising:
generating a score between the string and a data element of the node, the score based on a natural language processing technique; and
determining that the node matches the string in response to the score exceeding a predetermined threshold.

9. The method of claim 8, further comprising:
detecting another node in the customer ontology which is connected to the node matching the string; and
sending data of the another node to the user device.

10. The method of claim 1, wherein the first node represents any one of: a term, an attribute, a measure, a metric, a dimension, a filter, a key performance indicator (KPI), a data source, a user account, and a user identifier.

11. The method of claim 1, wherein the vertex includes an assigned weight.

12. A non-transitory computer readable medium having stored thereon instructions for causing a processing circuitry to execute a process, the process comprising:
receiving a data schema from a customer environment, the data schema including a plurality of semantic elements;
detecting a group of semantic elements in the plurality of semantic elements, the group corresponding to a unique element;
generating, for each unique element, a node in the customer ontology;
parsing a query received from the customer environment, the query including a first element and a second element;
determining a relationship between the first element and the second element based on the query; and
generating a vertex in the customer ontology between a first node representing the first element and a second node representing the second element, based on the determined relationship.

13. A system for generating a customer ontology for a business glossary, comprising:
a processing circuitry; and
a memory, the memory containing instructions that, when executed by the processing circuitry, configure the system to:
receive a data schema from a customer environment, the data schema including a plurality of semantic elements;
detect a group of semantic elements in the plurality of semantic elements, the group corresponding to a unique element;
generate, for each unique element, a node in the customer ontology;
parsing a query received from the customer environment, the query including a first element and a second element;
determine a relationship between the first element and the second element based on the query; and
generate a vertex in the customer ontology between a first node representing the first element and a second node representing the second element, based on the determined relationship.

14. The system of claim 13, wherein the memory contains further instructions that when executed by the processing circuitry, further configure the system to:
detect an overlap between the customer ontology and a global ontology, the overlap including: a first node of the global ontology corresponding to the first node of the customer ontology, and a second node of the global ontology corresponding to another node of the customer ontology, wherein the first node of the customer ontology is not connected to the another node, and the first node of the global ontology is connected by a first vertex to the second node of the global ontology; and
generate a second vertex, based on the first vertex, in the customer ontology, the second vertex connecting the first node of the customer ontology to the another node.

15. The system of claim 14, wherein the memory contains further instructions that when executed by the processing circuitry, further configure the system to:
detect an expert user account, the expert user account associated with a data source linked to the another node; and
send the expert user account a request to confirm that the another node is correctly linked to the data source.

16. The system of claim 15, wherein the memory contains further instructions that when executed by the processing circuitry, further configure the system to:
send the expert user account a request to confirm that the second vertex should connect the first node of the customer ontology to the another node.

17. The system of claim 16, wherein the memory contains further instructions that when executed by the processing circuitry, further configure the system to:
delete the second vertex from the customer ontology in response to receiving an instruction from the expert user account; and
generate a tag associated with the second vertex to indicate a verified connection, in response to receiving a confirmation from the expert user account.

18. The system of claim 15, wherein the memory contains further instructions that when executed by the processing circuitry, further configure the system to:
delete a vertex connecting a data node representing the data source to the another node, in response to receiving a response from the expert user account that the another node is not correctly linked to the data source; and
generate a tag associated with the vertex connecting the data node to the another node, in response to receiving a confirmation from the expert user account.

19. The system of claim 13, wherein the memory contains further instructions that when executed by the processing circuitry, further configure the system to:
receive a user generated input, the input including a string;
detect a node in the customer ontology which matches the string, the node including data; and
send the node data to a user device from which the user generated input was received.

20. The system of claim 19, wherein the memory contains further instructions that when executed by the processing circuitry, further configure the system to:
generate a score between the string and a data element of the node, the score based on a natural language processing technique; and
determine that the node matches the string in response to the score exceeding a predetermined threshold.

21. The system of claim 20, wherein the memory contains further instructions that when executed by the processing circuitry, further configure the system to:
detect another node in the customer ontology which is connected to the node matching the string; and
send data of the another node to the user device.

22. The system of claim 13, wherein the first node represents any one of: a term, an attribute, a measure, a metric, a dimension, a filter, a key performance indicator (KPI), a data source, a user account, and a user identifier.

23. The system of claim 13, wherein the vertex includes an assigned weight.
